(19) United States
(12) Patent Application Publication
(10) Pub. No.: US 2008/0106014 A1
(43) Pub. Date: May 8, 2008

(54) Pad for reducing or dampening noise or vibration

(76) Inventor: Joseph J. Gigl, Middletown, NJ (US)

Correspondence Address: Catalina & Associates, A Professional Corporation, Suite 2, 2355 State Highway 33, Robbinsville, NJ, 08691, US

(21) Appl. No.: 11/593,766

(22) Filed: Nov. 7, 2006

(51) Int. Cl. F16M 5/00

(52) U.S. Cl. 267/140

(57) ABSTRACT

A pump pad for the suppression of noise or vibration from a swimming pool motor and filtration pump. The pump pad is made from ultraviolet resistant, elastomeric material, such as Ethylene Propylene Diene Monomer (EPDM). The pump pad is placed on top of an equipment pad on which a swimming pool motor normally rests. The swimming pool pump and motor assembly is then placed on top of the pump pad, so that it is supported by the pump pad and isolated from the equipment pad underneath. The pump pad is resistant to the harsh chemicals used in swimming pool treatment, including chlorine and bromine and is also able to withstand long exposure to ultra-violet (UV) light as well as temperatures as high as the 120 degrees F. and as low as minus 10 degrees F.

### FIELD OF THE INVENTION

The present invention relates to an apparatus and method for noise and/or vibration reduction, and particularly, to pads comprised of elastomeric material, such as Ethylene Propylene Diene Monomer (EPDM), designed to reduce or dampen noise and/or vibration from sources of noise and/or vibration, such as swimming pool motors, filtration pumps and pump-motor assemblies.

### BACKGROUND OF THE INVENTION

One of the biggest complaints of swimming pool owners is noise or vibration caused by the swimming pool motor and/or filtration pump that is part of a typical swimming pool's water filtration system. Swimming pool owners in Arizona and California, for example, are concerned about such motor and pump noise or vibration, as those filtration units tend to be closer to the house. Indoor swimming pool owners are also susceptible to noise or vibration from the motor or pump.

What is needed is a cost efficient means of reducing noise and/or vibration from pool pumps or motors, which is further capable of withstanding accidental spills of the corrosive chemicals used in swimming pool treatment, including chlorine and bromine based chemicals. In addition, a further desirable characteristic of the noise and vibration reduction means would be the ability to withstand long exposure to ultra-violet (UV) light and to extreme temperatures that may reach as high as the 120 degrees F., which is common in Arizona in the summer, and as low as minus 10 degrees F., which is common in the North East states in the winter. Moreover, the noise reduction means should also last the life time of the swimming pool pump, i.e., about 5 to 7 years.

### SUMMARY OF THE INVENTION

Briefly described, the invention is a pad comprised of elastomeric material to reduce, dampen and suppress the noise and/or vibration from a swimming pool motor or filtration pump.

In a preferred embodiment, the pump pad is comprised of Ethylene Propylene Diene Monomer (EPDM), and has a substantially uniform desired (effective) thickness and is of a desired (effective) shape. In typical use, the pump pad is placed on top of the equipment pad on which the swimming pool motor and filtration pump (hereinafter, collectively, the “pump-motor assembly”) normally rest. The pump-motor assembly is then placed on top of the pump pad, so that the assembly is supported by the pump pad and isolated from the equipment pad underneath. The pump pad dampens the noise or vibration of the pump-motor assembly and further reduces or eliminates resonance of any noise or vibration by the equipment pad.

These and other features of the invention will be more fully understood by references to the following drawings.

### BRIEF DESCRIPTION OF THE DRAWINGS

FIG. 1 is a schematic side-view of a pump pad in use in reducing noise and vibration from a pump-motor assembly.

FIG. 2 is an isometric view of an exemplary pump pad of the present invention.

FIG. 3 is a plan view of an exemplary pump pad of the present invention.

FIG. 4 is a perspective view of a pump pad in use in reducing noise and vibration from a pump-motor assembly.

### DETAILED DESCRIPTION

The present invention applies to an apparatus and method for noise and vibration reduction, and in particular, to reduce noise and/or vibration produced by swimming pump-motor assemblies.

A preferred embodiment of the invention will now be described in detail by reference to the accompanying drawings in which, as far as possible, like elements are designated by like numbers.

Although every reasonable attempt is made in the accompanying drawings to represent the various elements of the embodiments in relative scale, it is not always possible to do so within the limitations of two-dimensional paper. Accordingly, in order to properly represent the relationships of various features among each other in the depicted embodiments and to properly demonstrate the invention in a reasonably simplified fashion, it is necessary at times to deviate from absolute scale in the attached drawings. However, one of ordinary skill in the art would fully appreciate and acknowledge any such scale deviations as not limiting the enablement of the disclosed embodiments.

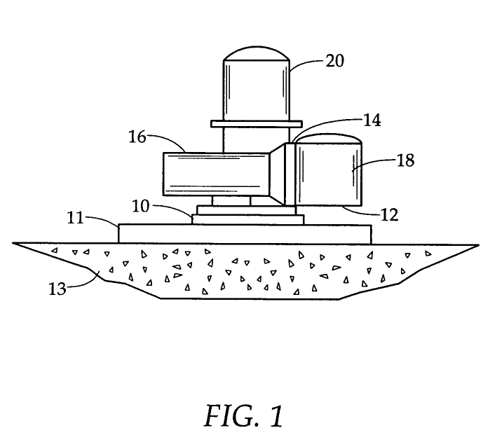

FIG. 1 is a schematic side-view of a pump pad 10 of the present invention being shown in use to reduce, dampen, suppress, reduce or isolate (hereinafter, generally, “dampen”) the noise and/or vibration caused by a swimming pool motor 16 and filtration pump 14. The pump pad 10 is placed on top of an equipment pad 11 that rests on the ground 13. The equipment pad 11 is typically a poured concrete slab, or it may be comprised or constructed of other materials generally known to those skilled in the art that provides even support for the pump-motor assembly 14, 16 and associated equipment. However, given the physical nature and characteristics of concrete and such other material, the equipment pad often resonates the sound and/or vibrations caused by the pump-motor assembly 14, 16 and other associated equipment, thereby further increasing the overall noise and/or vibration dramatically. The equipment associated with the pump-motor assembly 14, 16 may further include a strainer housed in a pump strainer basket housing 18. In addition, a filtration unit 20 may also rest on the equipment pad 11 and be attached to the filtration pump 14. The filtration unit 20 is typically a fiber glass, plastic or other synthetic material container filled with high grade sand, diatomaceous earth (DE) or other filtration media generally known to those skilled in the art.

The filtration pump 14 is typically a centrifugal pump used to move water from the swimming pool into the filtration unit 20. Given the tremendous resistance of the filtration media to the flow of the pool water through it, the pump-motor 14, 16 assembly must be of sufficient power to pump the water through the filtration system. Such motors 14 are generally in the range of ½ HP to 5 HP and therefore tend to create substantial noise and vibration. As such, the swimming pool motor 16 and the attached filtration pump 14 are prime sources of noise and vibration that require suppression or dampening. The pump pad 10 is designed both to absorb vibrations from the swimming pool motor 16, the filtration pump 14 and the associated equipment and to help prevent that noise and vibration from reaching the equipment pad 11 and being reverberated into the surrounding air.

The filtration unit 20 usually filters water from the swimming pool by allowing water to be pumped into the top of a sand-filled, whereupon the water flows down through the sand or other media under extreme pressure, for instance, 15 PSI. The sand filtering process within the filtration unit 20 does not necessarily contribute any noticeable noise, and therefore, does not need to rest on the pump pad 10. Non-sand filtering filtration unit 20, such as a diatomaceous earth (DE) filter or a cartridge filter, are similarly quiet and also do not need to necessarily rest on the pump pad 10. In a DE filter, water from the pool passes through filter grids coated with DE, a fine powder made from the chemically inert, fossilized remains of sea organisms called diatoms. In a cartridge filter, dirty water passes through a filter made out of polyester cloth or corrugated paper. Neither the DE filter systems nor the cartridge filter systems produce significant noise.

The strainer housed in the pump strainer basket housing 18 is typically intended to trap large debris. The pump strainer basket housing 18 is also where pool chemicals may be added to either sanitize or disinfect the pool or to control the pH of the pool water. The most popular pool disinfectant is chlorine, typically in the form of calcium hypochlorite (a solid) or sodium hypochlorite (a liquid). When added to the water, the chlorine reacts with the water to form various chemicals, most notably hypochlorous acid. Hypochlorous acid kills bacteria and other pathogens by attacking the lipids in the cell walls and destroying the enzymes and structures inside the cell through an oxidation reaction. Alternative sanitizers include bromides.

Most pool experts recommend a pool water pH level of about 7.2 to 7.8. To raise or lower pH, a pool owner adds acids or alkalis into the water. For example, adding sodium carbonate (soda ash) or sodium bicarbonate (baking soda) will generally raise the pH, and adding muriatic acid or sodium bisulfate will lower the pH.

Because various chemicals used to sanitize the pool water and control the pH of the pool water may be added via the pump strainer basket housing 18, those chemicals may splash, spill or fall onto the pump pad 10. The pump pad 10, therefore, needs to be made of a material that is resistant to these pools chemicals, i.e., chemicals including, but not limited to, chlorine, bromine, hypochlorous acid, sodium carbonate, sodium bicarbonate, muriatic acid and sodium bisulfate.

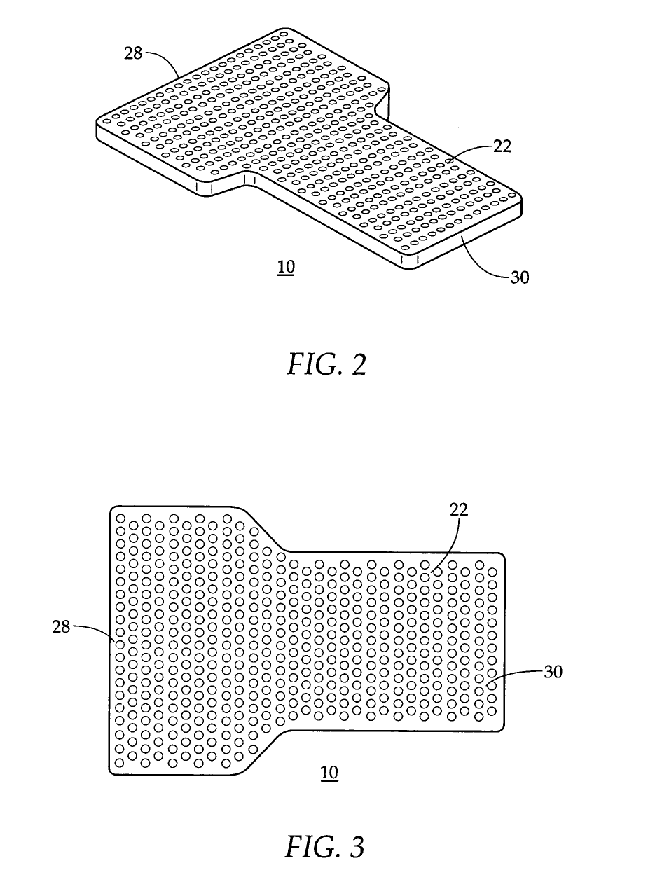

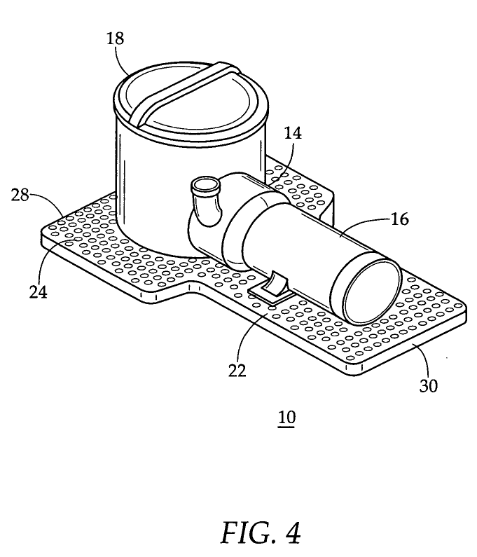

FIG. 2 is an isometric view of an exemplary pump pad 10 of the present invention and FIG. 3 is a plan view of the exemplary pump pad 10 of the present invention. FIG. 4 is a perspective view of an exemplary pump pad 10 of the present invention in use with a pump-motor assembly 14, 16.

Because the pump pad 10 could be exposed to sunlight or ultraviolet (UV) waves from other sources, it should be resistant to UV light and last the life time of swimming pool motor 16 and filtration pump 14 units, which generally last about 5 to 7 years.

In a preferred embodiment, the pump pad 10 is made from elastomeric material, such as Ethylene Propylene Diene Monomer (EPDM), or other synthetic rubber type material. EPDM is an elastomer and is used in many industrial applications including automotive weather-stripping. EPDM is resistant to UV light and pool chemicals. In addition, EPDM of the right hardness has effective acoustic vibration absorbing, dampening and isolating properties in the range of frequencies that typically characterize swimming pool motors 16 and filtration pumps 14. In a preferred embodiment, the pump pad 10 is made of EPDM having a hardness in the range of 65-80 durometers, as measured using a Shore type A durometer, and has a thickness of about 0.25 to 2 inches. EPDM of this hardness and thickness provides optimal acoustic isolation, dampening and absorption of the noise spectrum produced by a typical swimming pool motor 16 or filtration pump 14. The thickness of the pump pad 10, as well as its shape, discussed in greater detail below, may be created, formed or manufactured by cutting, slicing, synthesizing or molding EPDM material into a pad of desired thickness, shape and size.

As shown in FIGS. 2, 3 and 4, in a preferred embodiment, the pump pad 10 is generally shaped to correspond approximately to the footprint of a typical swimming pool motor 16 and attached filtration pump 14 with one end 28 wider than the opposite end 30. Such typical swimming pool pumps, motors and pump-motor assemblies include, but are not limited to, Hayward Super Pump Pool Pump, Hayward Power-Flow Pool Pumps, Pac-fab Pinnacle Pumps, Pac-fab Challenger Pumps, Sta-rite Pumps, Premeir Pool Pumps, or Speck Pool Pumps. This unique footprint or shape of the pump pad 10 accommodates the variation in noise volume or vibration strength from one end of the pump-motor assembly 14, 16 to the other end. In particular, the motor 16 end of the assembly, generally referred to as the “dry end,” produces a lower volume of noise (as measured in dB) and intensity of vibration than the opposite filtration pump 14 end of the assembly, which is generally referred to as the “wet end” of the pump-motor assembly 14, 16. The wet end of the assembly is generally louder and produces greater vibration than the dry end because there is greater turbulence in the water and/or resonance within the filtration system at the wet end of the assembly. For instance, the pump end 14 of the assembly is further directly connected to or housing for the pump strainer basket 18, which creates noise and vibration, as well as to the intake (from the pool) and outflow (to the filtration unit 20) pipes, tubes, etc. (not shown). These pipes, and their associated connections to the pump 14, also create significant noise and vibration. The unique design or shape of the pump pad 10 addresses the differences in the volume of noise and intensity of vibration that emanate from the opposite dry (motor 16) end and wet (pump 14) end of the pump-motor assembly 14, 16.

In a preferred embodiment, the length of the pump pad is generally of about 8 to 20 inches and the width of the pump pad is generally of about 4 to 12 inches at the “dry end” and of about 8 to 16 inches at the “wet end,” all depending on the size, power (HP) or configuration of the overall pump-motor assembly 14, 16.

In a preferred embodiment of the invention, the upper surface of the pad 22 may be an engineered textured surface 24 designed for maximum sound absorption. By patterning the upper surface of the pad 22 with ridges, pyramids or combinations of these and/or other shapes and textures 24 generally known to those skilled in the art, the sound is absorbed by the increased surface area and diffused by being reflected in different directions. Both the increased absorption and the diffusion of the sound improve the performance of the invention.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention. Modifications may readily be devised by those ordinarily skilled in the art without departing from the spirit or scope of the present

What is claimed is:

1. An apparatus for dampening noise or vibration, comprising:
a pad comprised of a noise or vibration dampening material of an effective thickness and effective shape, for dampening noise or vibration from a source.

2. The apparatus of claim 1, wherein said source of noise or vibration is a typical swimming pool pump, motor and/or pump-motor assembly.

3. The apparatus of claim 1, wherein the noise or vibration dampening material is resistant to ultraviolet (UV) rays.

4. The apparatus of claim 1, wherein the noise or vibration dampening material is Ethylene Propylene Diene Monomer (EPDM).

5. The apparatus of claim 1, wherein the pad is resistant to temperatures as high as about 120 degrees F. and as low as about minus 10 degrees F.

6. The apparatus of claim 1, wherein the thickness of the pad is substantially uniform.

7. The apparatus of claim 6, wherein the uniform thickness is of about 0.25 to 2 inches.

8. The apparatus of claim 1, wherein the shape is of the pad is of about a length of about 8 to 20 inches and a width of about 4 to 12 inches.

9. The apparatus of claim 4, wherein said EPDM material has a hardness in the range of about 65-80 durometers.

10. The apparatus of claim 2, wherein the shape of the pad is substantially the footprint of the swimming pool motor, pump and/or pump-motor assembly.

11. The apparatus of claim 1, wherein the shape of the pad comprises a wider end and a narrow end.

12. An apparatus for dampening noise or vibration, comprising:
a pad comprised of means for dampening noise or vibration from a source.

13. A method of dampening noise or vibration, comprising the steps of:
manufacturing a pad comprised of a noise or vibration dampening material of an effective thickness and effective shape, for dampening noise or vibration from a source; and,
placing said pad immediately adjacent to said source of noise or vibration.

14. The method of claim 13, wherein the pad is placed immediately beneath said source of noise or vibration.

15. The method of claim 14, wherein the source of noise or vibration is a typical swimming pool pump, motor and/or pump-motor assembly.

16. The method of claim 13, wherein the dampening material is comprised of Ethylene Propylene Diene Monomer (EPDM).

17. The method of claim 13, wherein the dampening material is resistant to temperatures as high as of about 120 degrees F. and as low as of about minus 10 degrees F.

18. The method of claim 13, wherein the pad is of substantially uniform thickness.

19. The method of claim 13, wherein the pad is of about 0.25 to 2 inches in thickness.

20. The method of claim 13, wherein the shape of the pad is of about 8 to 20 inches in length and of about 4 to 12 inches in width.

21. The method of claim 13, wherein the dampening material is of a hardness of about 65 to 80 durometers.

22. The method of claim 13, wherein the shape of the pad is of about 8 to 20 inches in length and of about 4 to 12 inches in width.

23. The method of claim 15 wherein said shape of the pad is the footprint or shape of said typical swimming pool pump, motor, or pump-motor assembly.

24. The method of claim 13, wherein the shape comprises a wider end and a narrow end.
